(19) United States
(12) Patent Application Publication
(10) Pub. No.: US 2010/0166290 A1
(43) Pub. Date: Jul. 1, 2010

(54) DIE DEFECT INSPECTING SYSTEM WITH A DIE DEFECT INSPECTING FUNCTION AND A METHOD OF USING THE SAME

(75) Inventors: Bily Wang, Hsinchu City (TW); Kuei-Pao Chen, Hsin Chu City (TW); Hsin-Cheng Chen, Jhudong Township (TW); Chien-Chi Huang, Hsinchu City (TW); Chung-Yi Tsai, Lugang Township (TW)

Correspondence Address: KILE GOEKJIAN REED & MCMANUS, 1200 NEW HAMPSHIRE AVE, NW, SUITE 570, WASHINGTON, DC, 20036, US

(73) Assignee: YOUNGTEK ELECTRONICS CORPORATION

(21) Appl. No.: 12/489,878

(22) Filed: Jun. 23, 2009

(30) Foreign Application Priority Data
Dec. 31, 2008 (TW) 97151558

(51) Int. Cl. G06K 9/00

(52) U.S. Cl. 382/149

(57) ABSTRACT

A die defect inspecting system with a die defect inspecting function includes a wafer-positioning module, an image-capturing module, a die-sucking module, a die defect analyzing module, a die-classifying module and a control module. The image-capturing module is disposed beside one side of the wafer-positioning module in order to capture an image of each die. The die-sucking module is disposed above the wafer-positioning module and the image-capturing module in order to suck each die from the wafer-positioning module to a position above the image-capturing module for capturing a back image of a back surface of each die. The die defect analyzing module is electrically connected to the image-capturing module in order to judge whether the back image of the back surface of each die passes inspection standard.

### CROSS-REFERENCE TO RELATED APPLICATION

This application claims priority under 35 U.S.C. § 119 to Taiwan Patent Application No. 097151558, filed on Dec. 31, 2008, in the Taiwan Intellectual Property Office, the entire contents of which are hereby incorporated by reference.

### BACKGROUND OF THE INVENTION

1. Field of the Invention

The present invention relates to a micro controller system, in particular, to a die defect inspecting system with a die defect inspecting function and a method of using the same.

2. Description of Related Art

In the semiconductor fabricating process, some small particles and defects are unavoidable. As the size of devices shrinks and the integration of circuits increases gradually, those small particles or defects affect the property of the integrated circuits more seriously. For improving the reliability of semiconductor devices, a plurality of tests are performed continuously to find the root cause of the defects or particles. Then, process parameters can be tuned correspondingly to reduce a presence of defects or particles so as to improve the yield and reliability of the semiconductor fabricating process.

In the prior art, a sampling is first performed to select a semiconductor wafer as a sample for following defect detection and analysis in advance. Then, a defect inspection is performed. Normally, a proper defect inspection machine is utilized to scan in a large scale to detect all defects on the semiconductor wafer. Since there are too many defects on a semiconductor wafer, a manual defect review with the SEM cannot be directly performed for all defects in practice. A manual defect classification is typically performed before the defect review. After separating the defects into different defect types, some defects are sampled for the defect review. Then, a defect root cause analysis may be performed in advance according to the result of the defect review to attempt to reduce the defect generation.

### SUMMARY OF THE INVENTION

In view of the aforementioned issues, the present invention provides a die defect inspecting system with a die defect inspecting function and a method of using the same. The present invention uses a die defect analyzing module to judge whether a back crack value of the periphery of the back image that has been captured is over a predetermined standard value. If the back crack value of the back image is not over the predetermined standard value, the die is placed on a go tray. If the back crack value of the back image is over the predetermined standard value, the die is placed on a no-go tray.

Moreover, the present invention uses the die defect analyzing module to judge whether a dirty mark value of the surface of the back image that has been captured is over a predetermined standard value. If the dirty mark value of the back image is not over the predetermined standard value, the die is placed on a go tray 50A. If the dirty mark value of the back image is over the predetermined standard value, the die is placed on a no-go tray.

To achieve the above-mentioned objectives, the present invention provides a method of using a die defect inspecting system with a die defect inspecting function, including: (a) positioning a wafer by a wafer-positioning module, wherein the wafer has a plurality of dies; (b) sucking one of the dies from the wafer-positioning module to a position above an image-capturing module by a die-sucking module; (c) capturing a back image of a back surface of the die by the image-capturing module; (d) judging whether a back crack value of the periphery of the back image captured in the step (c) is over a predetermined standard value by a die defect analyzing module; (e) if the back crack value of the back image captured in the step (c) is not over the predetermined standard value, the die sucked in the step (b) is placed on a go tray; if the back crack value of the back image captured in the step (c) is over the predetermined standard value, the die sucked in the step (b) is placed on a no-go tray; and (f) repeating the step (b) to the step (e) until the whole dies are placed on the go tray or the no-go tray.

To achieve the above-mentioned objectives, the present invention provides a die defect inspecting system with a die defect inspecting function, including: a wafer-positioning module, an image-capturing module, a die-sucking module, a die defect analyzing module, a die-classifying module and a control module. The wafer-positioning module is applied to position a wafer, and the wafer has a plurality of dies. The image-capturing module is disposed beside one side of the wafer-positioning module in order to capture an image of each die. The die-sucking module is disposed above the wafer-positioning module and the image-capturing module in order to suck each die from the wafer-positioning module to a position above the image-capturing module for capturing a back image of a back surface of each die.

Moreover, the die defect analyzing module is electrically connected to the image-capturing module in order to judge whether the back image of the back surface of each die passes inspection standard. The die-classifying module is disposed beside one side of the image-capturing module in order to classify the dies into go dies that pass inspection standard and no-go dies that do not pass inspection standard. The control module is electrically connected to the wafer-positioning module, the image-capturing module and the die-sucking module, in order to control the wafer-positioning module to position the wafer, to control the image-capturing module to capturing the back image of each die, and to control the die-sucking module to suck, move and release each die.

Therefore, if the back crack value of the back image is over the predetermined standard value, the back crack value is recorded as improvement reference information. If the dirty mark value of the back image is over the predetermined standard value, the dirty mark value is recorded as improvement reference information.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a functional block diagram of the die defect inspecting system according to the present invention;

FIG. 2 is a schematic view of the image-capturing module applied to capture the back image of each die by many capturing stage;

FIG. 3 is a flowchart of the method of using the die defect inspecting system according to the present invention;

FIGS. 4-1 and 4-2 are detail functional block diagrams of the step S106 according to the present invention;

FIG. 5 is a schematic view of the back image of the die according to the present invention;

FIG. 5A is an enlarged view of A part in FIG. 5;

FIG. 5B is an enlarged view of B part in FIG. 5;

FIG. 5C is an enlarged view of C part in FIG. 5;

FIG. 5D is an enlarged view of D part in FIG. 5;

FIG. 6 is a detail functional block diagram of the step S112 according to the present invention.

### DETAILED DESCRIPTION OF THE PREFERRED EMBODIMENTS

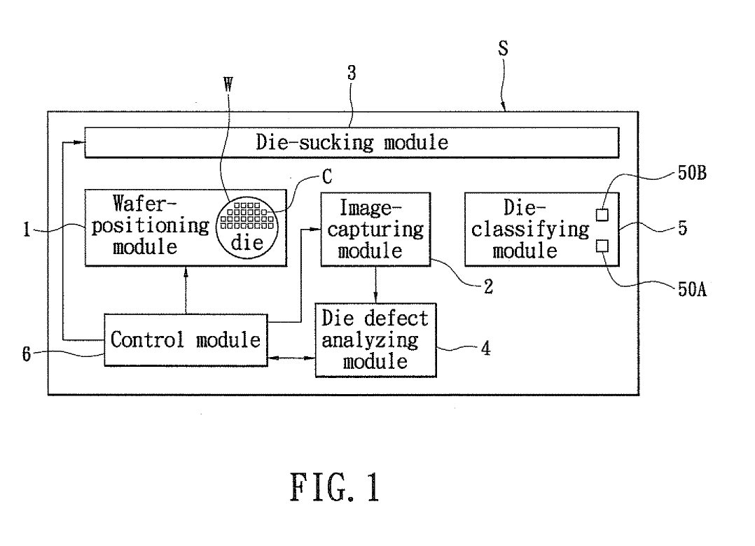

Referring to FIG. 1, the present invention provides a die defect inspecting system S with a die defect inspecting function, at least including: a wafer-positioning module 1, an image-capturing module 2, a die-sucking module 3, a die defect analyzing module 4, a die-classifying module 5 and a control module 6.

The wafer-positioning module 1 is applied to position a wafer W, and the wafer W has a plurality of dies C. The image-capturing module 2 is disposed beside one side of the wafer-positioning module 1 in order to capture an image of each die C.

Moreover, the die-sucking module 3 is disposed above the wafer-positioning module 1, the image-capturing module 2 and the die-classifying module 5 in order to suck each die C from the wafer-positioning module 1 to a position above the image-capturing module 2 for capturing a back image of a back surface of each die C. In addition, the die-sucking module 3 can be a vacuum suction device.

Furthermore, the die defect analyzing module 4 is electrically connected to the image-capturing module 2 in order to judge whether the back image of the back surface of each die C passes inspection standard. For example, the die defect analyzing module 4 is applied to judge whether each die C passes a predetermined inspection standard value such as a back crack value or a dirty mark value.

In addition, the die-classifying module 5 is disposed beside one side of the image-capturing module 2 in order to classify the dies C into go dies that pass inspection standard and no-go dies that do not pass inspection standard. The die-classifying module 5 has a go tray 50A for receiving the go dies and a no-go tray 50B for receiving the no-go dies.

Moreover, the control module 6 is electrically connected to the wafer-positioning module 1, the image-capturing module 2 and the die-sucking module 3, in order to control the wafer-positioning module 1 to position the wafer W, to control the image-capturing module 2 to capturing the back image of each die C, and to control the die-sucking module 3 to suck, move and release each die C.

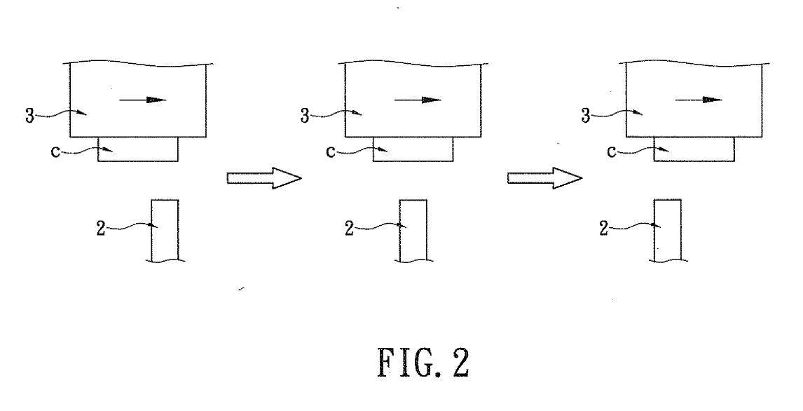

The back image of the back surface of each die C is captured by one capturing stage, so that the image-capturing module 2 can be applied to capture the back image of each die C by one capturing stage. The back image of the back surface of each die C is captured by many capturing stages, so that the image-capturing module 2 can be applied to capture the back image of each die C by many capturing stage. Referring to FIG. 2, the image-capturing module 2 is applied to capture the back image of each die C by three capturing stages.

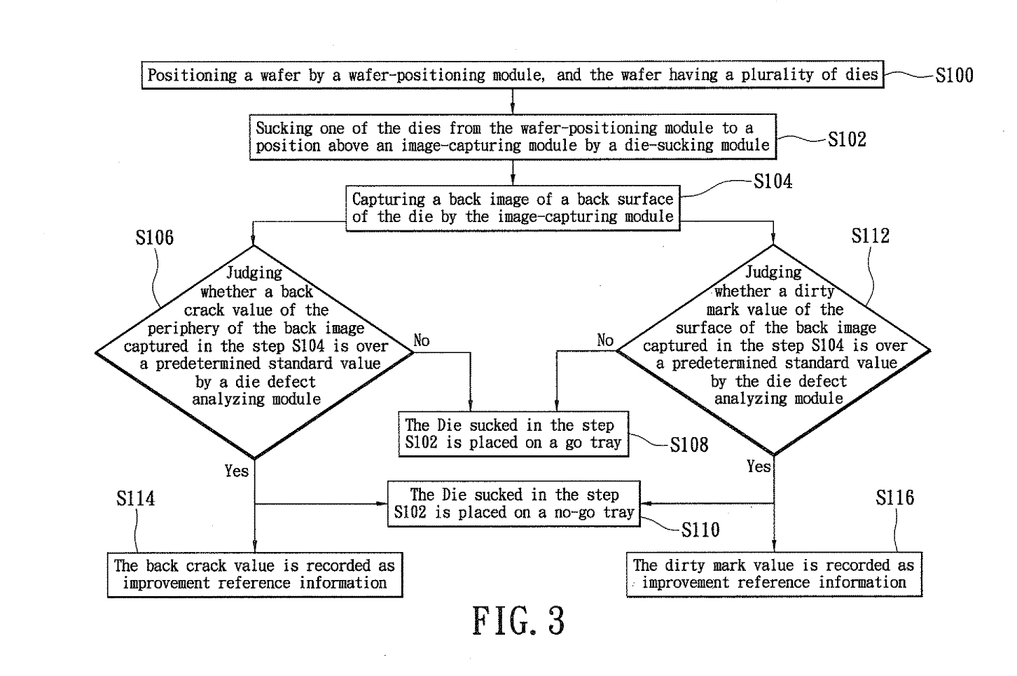

Referring to FIG. 3, the present invention provides a method of using a die defect inspecting system with a die defect inspecting function, including the following steps:

Step S100 is that: positioning a wafer W by a wafer-positioning module 1, and the wafer W having a plurality of dies C.

Step S102 is that: sucking one of the dies C from the wafer-positioning module 1 to a position above an image-capturing module 2 by a die-sucking module 3.

Step S104 is that: capturing a back image of a back surface of the die C by the image-capturing module 2. In addition, the back image of the back surface of the die C is captured by one capturing stage or many capturing stages.

Step S106 is that: judging whether a back crack value of the periphery of the back image captured in the step S104 is over a predetermined standard value by a die defect analyzing module 4.

Step S108 is that: if the back crack value of the back image captured in the step S104 is not over the predetermined standard value, the die C sucked in the step S102 is placed on a go tray 50A.

Step S110 is that: if the back crack value of the back image captured in the step S104 is over the predetermined standard value, the die C sucked in the step S102 is placed on a no-go tray 50B.

Step S112 is that: judging whether a dirty mark value of the surface of lie back image captured in the step S104 is over a predetermined standard value by the die defect analyzing module 4.

Hence, if the dirty mark value of the back image captured in the step S104 is not over the predetermined standard value, executing the step S108 (the die C sucked in the step S102 is placed on a go tray 50A). If the dirty mark value of the back image captured in the step S104 is over the predetermined standard value, executing the step S108 (the die C sucked in the step S102 is placed on a no-go tray 50B).

Step S114 is that: if the back crack value of the back image captured in the step S104 is over the predetermined standard value, the back crack value is recorded as improvement reference information.

Step S116 is that: if the dirty mark value of the back image captured in the step S104 is over the predetermined standard value, the dirty mark value is recorded as improvement reference information.

Final step is that: repeating the step S102 to the step S116 until the whole dies C are placed on the go tray 50A or the no-go tray 50B.

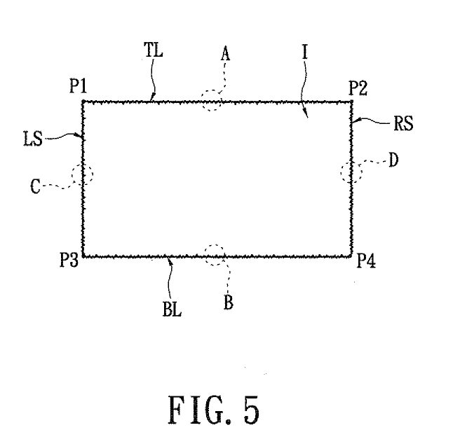

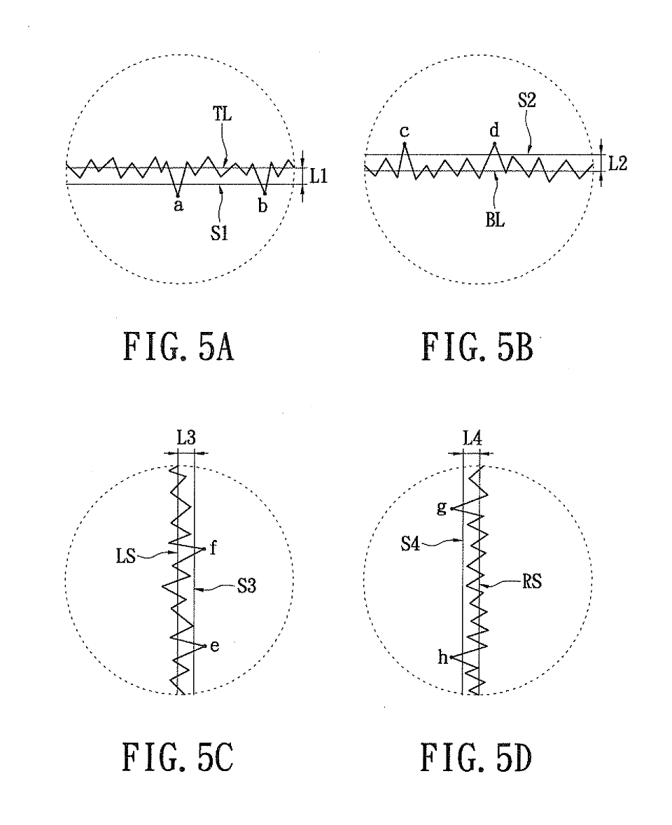

Referring to FIG. 5, the periphery of the back image I is composed of a long top side TL, a long bottom side BL, a short left side LS and a short right side RS.

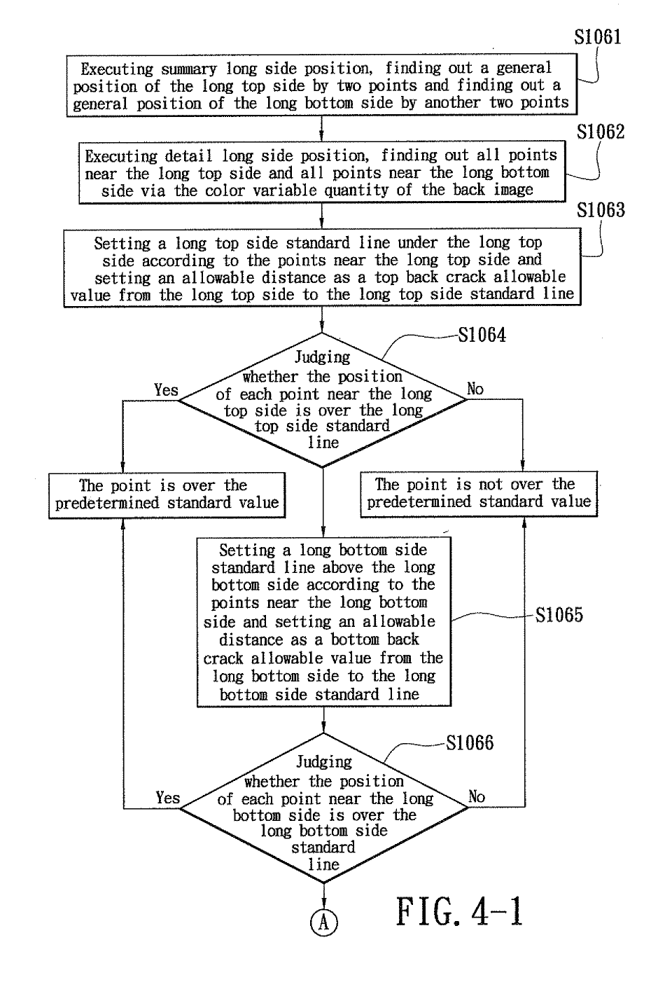

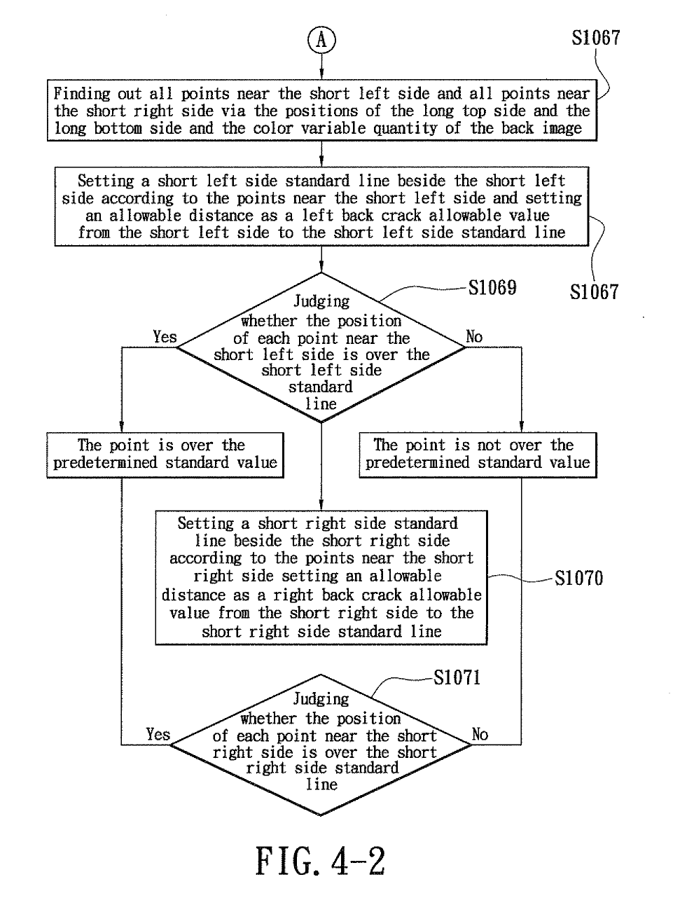

Referring to FIGS. 4-1 and 4-2, the step S106 further comprises the following steps:

Step S1061 is that: executing summary long side position, finding out a general position of the long top side TL by two points (P1, P2) and finding out a general position of the long bottom side BL by another two points (P3, P4).

Step S1062 is that: executing detail long side position, finding out all points near the long top side TL and all points near the long bottom side BL via the color variable quantity of the back image I.

Step S1063 is that: setting a long top side standard line S1 under the long top side TL according to the points near the long top side TL and setting an allowable distance L1 as a top back crack allowable value from the long top side TL to the long top side standard line S1.

Step S1064 is that: judging whether the position of each point near the long top side TL is over the long top side standard line S1; if no, the point near the long top side TL is not over the predetermined standard value; if yes, the point near the long top side TL is over the predetermined standard value.

For example, referring to FIG. 5A, there are two points (a, b) near the long top side TL is over the long top side standard line S1 (is over the top back crack allowable value), so that the two points (a, b) near the long top side TL is over the predetermined standard value.

Step S1065 is that: setting a long bottom side standard line S2 above the long bottom side BL according to the points near the long bottom side BL and setting an allowable distance L2 as a bottom back crack allowable value from the long bottom side BL to the long bottom side standard line S2.

Step S1066 is that: judging whether the position of each point near the long bottom side BL is over the long bottom side standard line S2; if no, the point near the long bottom side BL is not over the predetermined standard value; if yes, the point near the long bottom side BL is over the predetermined standard value.

For example, referring to FIG. 5B, there are two points (c, d) near the long bottom side BL is over the long top side standard line S2 (is over the bottom back crack allowable value), so that the two points (c, d) near the long bottom side BL is over the predetermined standard value.

Step S1067 is that: finding out all points near the short left side LS and all points near the short right side RS via the positions of the long top side TL and the long bottom side BL and the color variable quantity of the back image I.

Step S1068 is that: setting a short left side standard line S3 beside the short left side LS according to the points near the short left side LS and setting an allowable distance L3 as a left back crack allowable value from the short left side LS to the short left side standard line S3.

Step S1069 is that: judging whether the position of each point near the short left side LS is over the short left side standard line S3; if no, the point near the short left side LS is not over the predetermined standard value; if yes, the point near the short left side LS is over the predetermined standard value.

For example, referring to FIG. 5C, there are two points (e, f) near the short left side LS is over the short left side standard line S3 (is over the left back crack allowable value), so that the two points (e, f) near the short left side LS is over the predetermined standard value.

Step S1070 is that: setting a short right side standard line S4 beside the short right side RS according to the points near the short right side RS and setting an allowable distance L4 as a right back crack allowable value from the short right side RS to the short right side standard line S4.

Step S1071 is that: judging whether the position of each point near the short right side RS is over the short right side standard line S4; if no, the point near the short right side RS is not over the predetermined standard value; if yes, the point near the short right side RS is over the predetermined standard value.

For example, referring to FIG. 5D, there are two points (g, h) near the short right side RS is over the short right side standard line S4 (is over the right back crack allowable value), so that the two points (g, h) near the short right side RS is over the predetermined standard value.

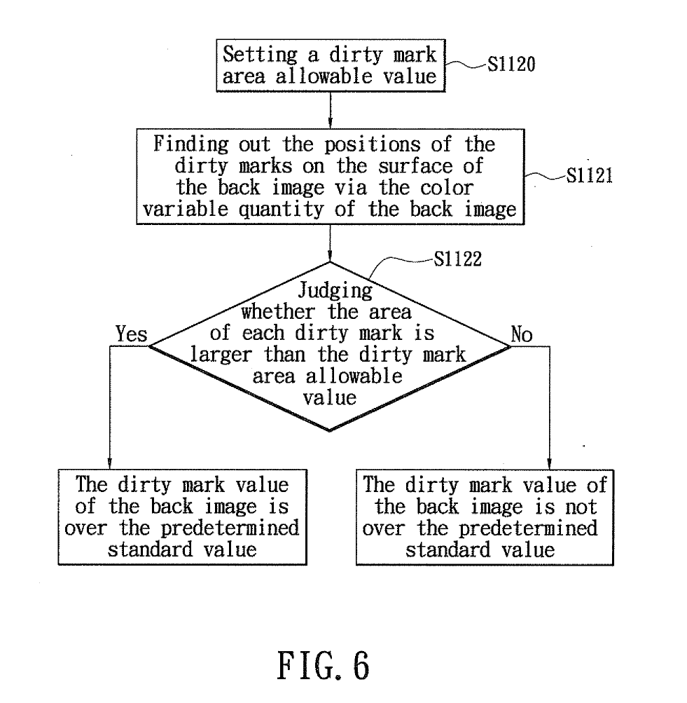

Referring to FIG. 6, the step S112 of judging whether the dirty mark value of the surface of the back image I captured in the step S104 is over the predetermined standard value further includes the following steps:

Step S1120 is that: setting a dirty mark area allowable value.

Step S1121 is that: finding out the positions of the dirty marks on the surface of the back image I via the color variable quantity of the back image.

Step S1122 is that: judging whether the area of each dirty mark is larger than the dirty mark area allowable value; if no, the dirty mark value of the back image I captured in the step S104 is not over the predetermined standard value; if yes, the dirty mark value of the back image I captured in the step S104 is over the predetermined standard value.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method of using a die defect inspecting system with a die defect inspecting function, comprising:
(a) positioning a wafer by a wafer-positioning module, wherein the wafer has a plurality of dies;
(b) sucking one of the dies from the wafer-positioning module to a position above an image-capturing module by a die-sucking module;
(c) capturing a back image of a back surface of the die by the image-capturing module;
(d) judging whether a back crack value of the periphery of the back image captured in the step (c) is over a predetermined standard value by a die defect analyzing module;
(e) if the back crack value of the back image captured in the step (c) is not over the predetermined standard value, the die sucked in the step (b) is placed on a go tray; if the back crack value of the back image captured in the step (c) is over the predetermined standard value, the die sucked in the step (b) is placed on a no-go tray; and
(f) repeating the step (b) to the step (e) until the whole dies are placed on the go tray or the no-go tray.

2. The method according to claim 1, wherein if the back crack value of the back image captured in the step (c) is over the predetermined standard value, the back crack value is recorded as improvement reference information.

3. The method according to claim 1, wherein the periphery of the back image is composed of a long top side, a long bottom side, a short left side and a short right side, and the step (d) further comprising:
finding out a general position of the long top side by two points and finding out a general position of the long bottom side by another two points;
finding out all points near the long top side and all points near the long bottom side via the color variable quantity of the back image;
setting a long top side standard line under the long top side according to the points near the long top side and setting an allowable distance as a top back crack allowable value from the long top side to the long top side standard line;
judging whether the position of each point near the long top side is over the long top side standard line; if no, the point near the long top side is not over the predetermined standard value; if yes, the point near the long top side is over the predetermined standard value;
setting a long bottom side standard line above the long bottom side according to the points near the long bottom side and setting an allowable distance as a bottom back crack allowable value from the long bottom side to the long bottom side standard line;
judging whether the position of each point near the long bottom side is over the long bottom side standard line; if no, the point near the long bottom side is not over the predetermined standard value; if yes, the point near the long bottom side is over the predetermined standard value;
finding out all points near the short left side and all points near the short right side via the positions of the long top side and the long bottom side and the color variable quantity of the back image;
setting a short left side standard line beside the short left side according to the points near the short left side and setting an allowable distance as a left back crack allowable value from the short left side to the short left side standard line;
judging whether the position of each point near the short left side is over the short left side standard line; if no, the point near the short left side is not over the predetermined standard value; if yes, the point near the short left side is over the predetermined standard value;
setting a short right side standard line beside the short right side according to the points near the short right side and setting an allowable distance as a right back crack allowable value from the short right side to the short right side standard line; and
judging whether the position of each point near the short right side is over the short right side standard line; if no, the point near the short right side is not over the predetermined standard value; if yes, the point near the short right side is over the predetermined standard value.

4. The method according to claim 1, wherein the back image of the back surface of the die is captured by one capturing stage or many capturing stages.

5. The method according to claim 1, wherein the step (d) further comprising: judging whether a dirty mark value of the surface of the back image captured in the step (c) is over a predetermined standard value by the die defect analyzing module.

6. The method according to claim 5, wherein the step (e) further comprising: if the dirty mark value of the back image captured in the step (c) is not over the predetermined standard value, the die sucked in the step (b) is placed on a go tray; if the dirty mark value of the back image captured in the step (c) is over the predetermined standard value, the die sucked in the step (b) is placed on a no-go tray.

7. The method according to claim 6, wherein if the dirty mark value of the back image captured in the step (c) is over the predetermined standard value, the dirty mark value is recorded as improvement reference information.

8. The method according to claim 5, wherein the step of judging whether the dirty mark value of the surface of the back image captured in the step (c) is over the predetermined standard value further comprising:
setting a dirty mark area allowable value;
finding out the positions of the dirty marks on the surface of the back image via the color variable quantity of the back image; and
judging whether the area of each dirty mark is larger than the dirty mark area allowable value; if no, the dirty mark value of the back image captured in the step (c) is not over the predetermined standard value; if yes, the dirty mark value of the back image captured in the step (c) is over the predetermined standard value.

9. The method according to claim 1, wherein the image-capturing module is disposed beside one side of the wafer-positioning module, the die-sucking module is disposed above the wafer-positioning module and the image-capturing module, and the die defect analyzing module is electrically connected to the image-capturing module.

10. The method according to claim 1, wherein the die-sucking module is a vacuum suction device.

11. A die defect inspecting system with a die defect inspecting function, comprising:
a wafer-positioning module for positioning a wafer, wherein the wafer has a plurality of dies;
an image-capturing module disposed beside one side of the wafer-positioning module in order to capture an image of each die;
a die-sucking module disposed above the wafer-positioning module and the image-capturing module in order to suck each die from the wafer-positioning module to a position above the image-capturing module for capturing a back image of a back surface of each die;
a die defect analyzing module electrically connected to the image-capturing module in order to judge whether the back image of the back surface of each die passes inspection standard;
a die-classifying module disposed beside one side of the image-capturing module in order to classify the dies into go dies that pass inspection standard and no-go dies that do not pass inspection standard; and
a control module electrically connected to the wafer-positioning module, the image-capturing module and the die-sucking module, in order to control the wafer-positioning module to position the wafer, to control the image-capturing module to capturing the back image of each die, and to control the die-sucking module to suck, move and release each die.

12. The die defect inspecting system according to claim 11, wherein the die-sucking module is a vacuum suction device.

13. The die defect inspecting system according to claim 11, wherein the die-classifying module has a go tray for receiving the go dies and a no-go tray for receiving the no-go dies.
